(19) United States
(12) Patent Application Publication
(10) Pub. No.: US 2004/0076299 A1
(43) Pub. Date: Apr. 22, 2004

(54) Cryptography in data compression

(76) Inventor: Chung-E Wang, Sacramento, CA (US)

Correspondence Address: CHUNG-E WANG, 845 WEST COVE WAY, SACRAMENTO, CA, 95831, US

(21) Appl. No.: 10/065,452

(22) Filed: Oct. 18, 2002

(51) Int. Cl. H04K 1/00

(52) U.S. Cl. 380/269

(57) ABSTRACT

Cryptographic methods for concealing information in data compression processes. The invention includes novel approaches of introducing pseudo random shuffles into the processes of dictionary coding (Lampel-Ziv compression), Huffman coding, and arithmetic coding.

### BACKGROUND OF INVENTION

1. Field of Invention

The present invention relates to data encryption and data compression. More specifically, it deals with performing data encryption and data compression simultaneously.

2. Background

Data compression is known for reducing storage and communication costs. It involves transforming data of a given format, called source message, into data of a smaller sized format, called codeword.

Data encryption is known for protecting information from eavesdropping. It transforms data of a given format, called plaintext, to another format, called cipher text, using an encryption key.

The major problem existing with the current compression and encryption methods is the speed, i.e. the processing time required by a computer. To help minimize the problem, I combine the two processes into one.

### SUMMARY OF INVENTION

Cryptographic methods for concealing information in data compression processes are revealed. The invention includes novel approaches of introducing pseudo random shuffles into the processes of the dictionary coding (Lampel-Ziv compression), Huffman coding, and the arithmetic coding.

### BRIEF DESCRIPTION OF DRAWINGS

FIG. 1 is a block diagram illustrating the steps of combining a random shuffle with a Lampel-Ziv data compression.

FIG. 2 shows the detail of the bit-wise exclusive OR step used in step 140.

FIG. 3 is a block diagram illustrating the steps of simultaneous Lampel-Ziv decompression and decryption.

FIG. 4 shows the detail of the bit-wise exclusive OR step used in step 330.

FIG. 5 shows a sample Huffman tree.

FIG. 6 shows the top-down left-right numbering of the interior nodes.

FIG. 7 shows the Huffman tree of FIG. 5 after the shuffling with an encryption key.

FIG. 8 is an example illustrating the process of an arithmetic coding without a pseudo random shuffle.

FIG. 9 is a block diagram illustrating steps of concealing information in the process of arithmetic coding.

FIG. 10 is an example illustrating the process of an arithmetic coding with a pseudo random shuffle.

### DETAILED DESCRIPTION

The basic idea of this invention is to combine pseudo random shuffles with data compressions. The method of using a pseudo random number generator to create a pseudo random shuffle is well known. A simple algorithm as below can do the trick. Assume that we have a list (x₁, . . . , xₙ) and we want to shuffle it randomly.

for i=n downto 2 {k=random(1,i); swap xᵢ and xₖ}

### 1. Adding a Pseudo Random Shuffle to Dictionary Coding (LZ Compression)

The basic idea of Lampel-Ziv (LZ) compression is to replace a group of consecutive characters with an index into a dictionary that is built during the compression process. There are many implementations of the LZ compression. Different implementations of the LZ compression have different ways of implementing the dictionary. For further discussion of LZ compressions, refer to “A universal algorithm for sequential data compression”, J. Ziv and A. Lampel, IEEE Trans. Inf. Theory 23 (1977), 3 (May) pp. 337-343.

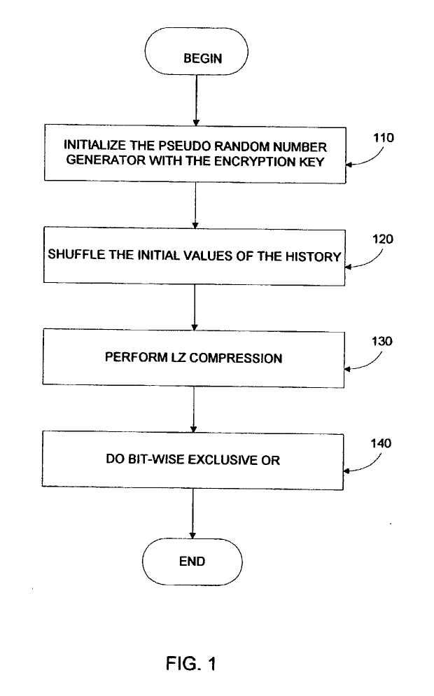

FIG. 1 illustrates the steps of combining a random shuffle with an LZ compression to achieve the simultaneous encryption and compression. In step 110, the encryption key is used to initialize a pseudo random number generator. In step 120, the pseudo random number generator is used to shuffle the initial values of the dictionary.

In a codebook type of implementation, e.g. LZW compression, i.e. Welch's implementation of the LZ compression, the dictionary consists of strings of characters. Initially, it contains all strings of length l in alphabetical order. In this case, step 120 shuffles strings of length l. So, the dictionary begins with strings of length l in random order. For a further discussion of LZW compressions, refer to “A technique for high-performance data compression”, T. A. Welch, Computer 17 (1984), 6 (June), pp 8-19.

In a sliding window type of implementation, e.g. LZ77, the dictionary is a window that consists of last n characters processed. Initially, the window is empty. In this case, step 120 initializes the window with the set of all characters of the alphabet and then shuffles the window. For a further discussion of LZ77, refer to “A universal algorithm for sequential data compression”, J. Ziv and A. Lampel, IEEE Trans. Inf. Theory 23 (1977), 3 (May), pp. 337-343.

In step 130, the compression process is performed on the input string in its usual fashion.

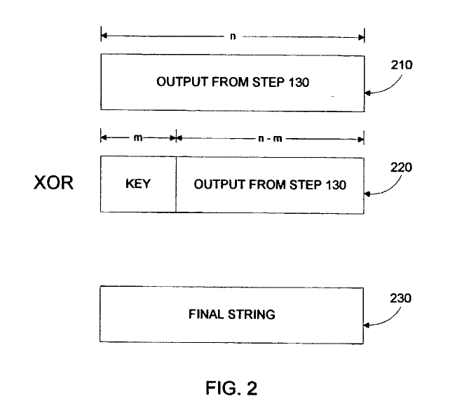

In step 140, the mathematical bit-wise exclusive OR (XOR) operation is performed between the output of step 130 and the concatenation of the encryption key and the output of step 130. FIG. 2 shows the detail of step 140. Assume that the length of the encryption key is m and the length of the output of step 130 is n. Block 210 is the output of step 130. Block 220 is the concatenation of the encryption key and the first (n-m) characters of the output of step 130. Block 230 is the result of performing the bit-wise XOR between blocks 210 and 220. Block 230 is the final compressed and encrypted string.

Note that in an actual implementation, step 130 and step 140 can be done together in the same loop.

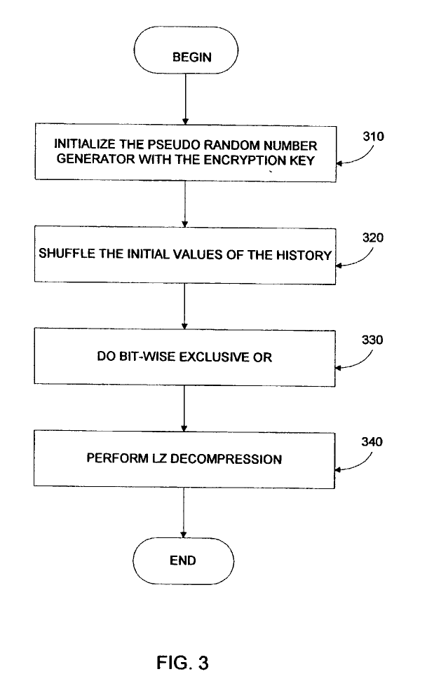

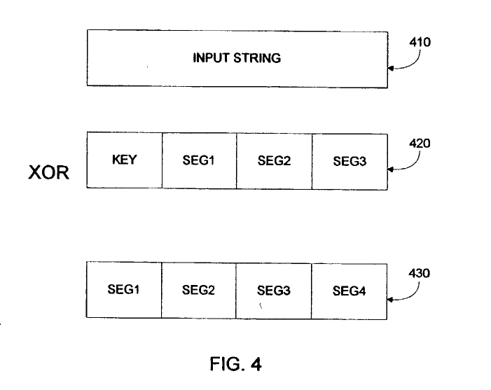

FIG. 3 illustrates the steps of simultaneous decompression and decryption. In step 310, the encryption key is used to initialize a pseudo random number generator. Note that the pseudo random number generator used in step 310 should be identical to the one used in step 110. In step 320, the pseudo random number generator is used to shuffle the initial values of the dictionary. In step 330, the bit-wise XOR is performed on the input string and the encryption key as in FIG. 4. In step 340, the decompression is performed on the output of step 330 in its usual fashion. The output of step 340 is the final decompressed and decrypted string.

In FIG. 4, block 410 is the input string. Logically, block 420 is the concatenation of the encryption key and block 430. However, block 430 is the result of performing the bit-wise XOR operation between blocks 410 and 420. In other words, blocks 420 and 430 depend on each other and thus must be built gradually. First, the bit-wise XOR is performed between the encryption key and the corresponding portion in block 410 to produce SEG1 in block 430. Then the bit-wise XOR is performed between the SEG1 of block 420 and the corresponding portion in block 410 to produce SEG2, . . . , etc. Block 430 is the output of step 330.

Note that in an actual implementation, step 330 and step 340 could be done together in the same loop.

### 2. Adding a Pseudo Random Shuffle to the Huffman Coding

Huffman coding is a simple compression algorithm introduced by David Huffman in 1952. The basic idea of Huffman coding is to construct a tree, called a Huffman tree, in which each character has it's own branch determining its code.

A Huffman coding could be static or adaptive. In a static Huffman coding, the Huffman tree stays the same in the entire coding process. In an adaptive Huffman coding, the Huffman tree changes according to the data processed.

For further discussion about static and adaptive Huffman coding, refer to the following.

Cormack, G. V., and Horspool, R. N. 1984. Algorithms for Adaptive Huffman Codes. Inform. Process. Lett 18, 3 (Mar), 159-165.

Faller, N. 1973. An adaptive system for data compression. In Record of the 7^{th} Asilomar Conference on Circuits, Systems and Computers (Pacific Grove, Calif., November). Naval Postgraduate School, Monterey, Calif., pp. 593-597.

Huffman, D. A. 1952. A Method for the Construction of Minimum-Redundancy Codes. Proc. IRE40, 9 (September), 1098-1101.

Knuth, D. E. 1985. Dynamic Huffman Coding. J. Algorithms 6, 2 (June), 163-180.

Gallager, R. G. 1978. Variations on a theme by Huffman. IEEE Trans. Inf. Theory 24, 6 (November) 668-674

Vitter, J. S. 1987. Design and analysis of dynamic Huffman codes. J. ACM 34, 4 (October), 825-845.

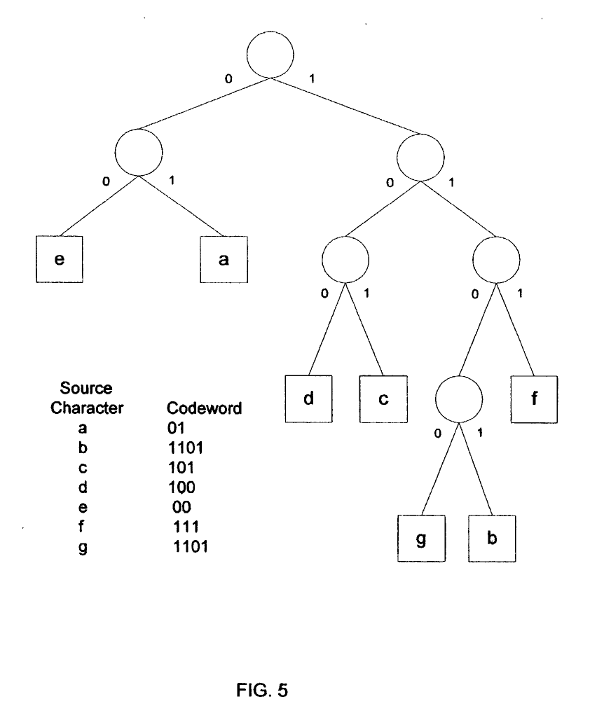

Once the Huffman tree is built, regardless of it being static or adaptive, the encoding process is identical. The codeword for each source character is the sequence of labels along the path from the root to the leave node representing that character. For example, in FIG. 5, the codeword for “a” is “01”, “b” is “1101”, etc.

The basic idea of concealing information in Huffman coding is to use an encryption key to shuffle the Huffman tree before the encoding process. Without the encryption key, the Huffman tree cannot be shuffled in the same way and thus the decompression cannot be done properly. Consequently, the original information cannot be retrieved.

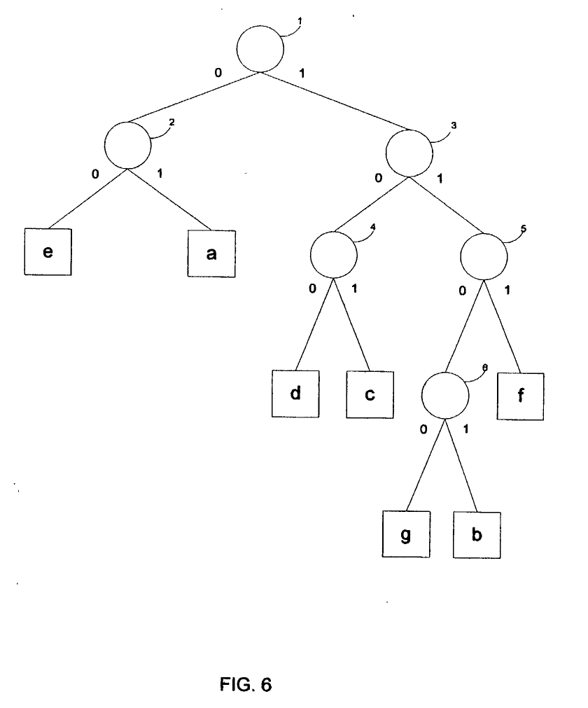

To shuffle a Huffman tree, first, the interior nodes, nodes with 2 children, are numbered. There are many ways of numbering these interior nodes. For example, by performing a queue traversal on the Huffman tree, the interior nodes can be numbered in the top-down, left-right fashion. FIG. 6 shows the top-down, left-right numbering of the interior nodes of the Huffman tree in FIG. 5.

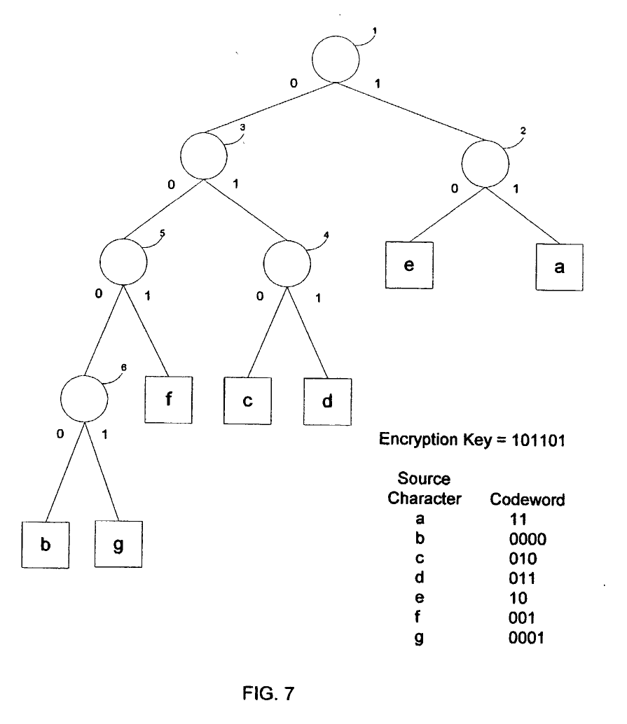

Secondly, bits of the encryption key are associated with the interior nodes according to the numbering; the interior node 1 is associated with the first bit of the encryption key, the interior node 2 is associated with the second bit of the encryption key, etc. Finally, of each interior node that has a corresponding encryption bit of 1, the left child is swapped with the right child. In FIG. 7, the encryption key used is “101101”. Thus, the two children of interior nodes 1, 3, 4, and 6 are swapped. After the shuffling, the codewords of source characters are changed dramatically and cannot be decoded without the identical shuffled Huffman tree.

### 3. Adding a Pseudo Random Shuffle to the Arithmetic Coding

In arithmetic coding, a message of any length is coded as a real number between 0 and 1. The longer the message the more precision is used to code the message. This is done as follows:

1) Initialize the current interval with the interval [0,1), i.e. the set of real numbers from 0 to 1, including 0 and excluding 1.

2) Divide the current interval into smaller intervals such that each character has a corresponding smaller interval with a length proportional to its probability.

3) From these new intervals, choose the one corresponding to the next character in the message.

4) Continue to do steps 2) and 3) until the whole message is coded.

5) Represent the interval's value using a binary fraction.

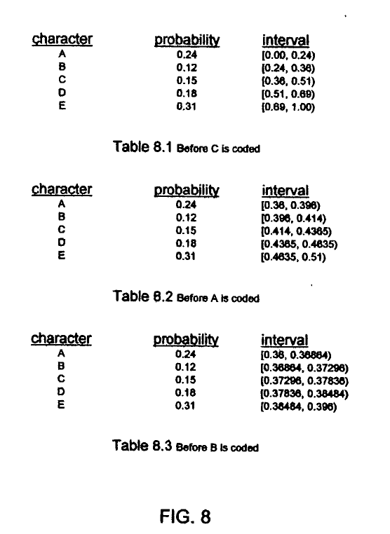

FIG. 8 shows an example. The message to be coded is “CAB”. Probabilities of characters are repeated in all three tables. Table 8.1 shows the intervals before the coding of the 1^{st} character “C”. Table 8.2 shows the intervals before the coding of the 2^{nd} character “A”. Table 8.3 shows the intervals before the coding of the 3^{rd} character “B”. The number 0.36864 is the final result of the arithmetic coding. For further discussion of arithmetic coding, refer to “Arithmetic coding for data compression”, Witten, I. H., Neal, R. M., and Cleary, J. G., Communications of the ACM, vol. 30 (1987), pp. 520-540 and “Arithmetic coding revisited”, Moffat, A., Neal, R. M., and Witten, I. H., ACM Transactions on Information Systems, vol. 16 (1995), pp. 256-294.

The basic idea of concealing information in the process of arithmetic coding is to use an encryption key to shuffle the interval table before the coding process. Without the encryption key, the interval table cannot be shuffled in the same way and the division of an interval into smaller intervals won't be the same and thus decompression cannot be done properly. Consequently, the original information cannot be retrieved.

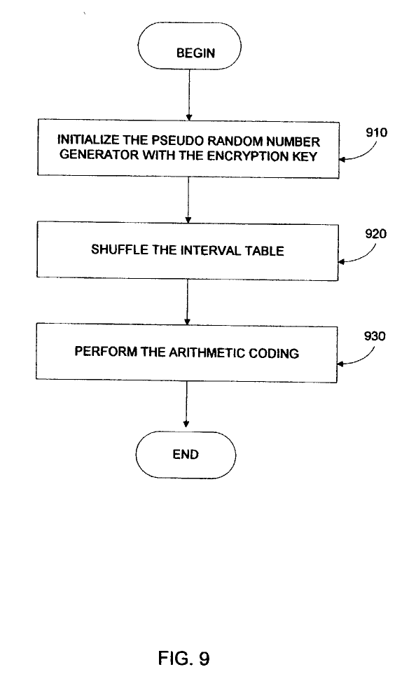

FIG. 9 illustrates the steps of combining a random shuffle with the arithmetic coding. In step 910, the encryption key is used to initialize a pseudo random number generator. In step 920, the pseudo random number generator is used to shuffle the interval table. In step 930, the arithmetic coding process is performed on the input message in its usual fashion.

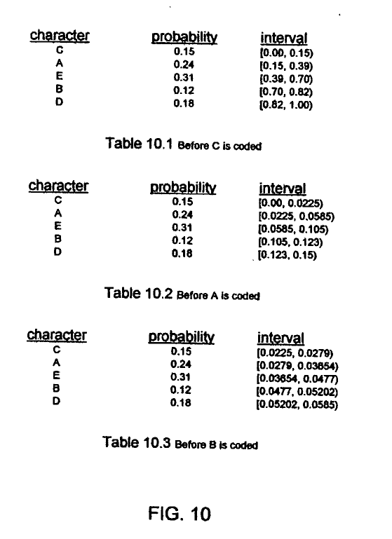

FIG. 10 shows the effect of a pseudo random shuffle. Table 10.1 shows the intervals before the coding of the 1^{st} character “C”. Table 10.2 shows the intervals before the coding of the 2^{nd} character “A”. Table 10.3 shows the intervals before the coding of the 3^{rd} character “B”. The number 0.0477 is the final result of the arithmetic coding.

1. A method of introducing randomness into the process of the dictionary encoding of Lampel-Ziv data compression by shuffling the initial values of the dictionary with the encryption key.

2. A method for combining a random shuffle with a Lampel-Ziv data compression to achieve a simultaneous data compression and encryption, comprised of the following steps:
a) Use the encryption key to shuffle the initial values of the dictionary randomly.
b) Compress the input string normally.
c) Perform the bit-wise XOR operation on the compressed result and the encryption key.

3. A method as defined in claim 2, where step a) is comprised of the following step:
a) If the dictionary doesn't have any initial values, initialize the dictionary with a particular set of values and then use the encryption key to shuffle the dictionary.

4. A cryptographic method of concealing information in the process of Huffman coding by altering the Huffman tree with an encryption key.

5. A method of shuffling the Huffman tree with an encryption key comprised of the following steps:
a) Associate each interior node with a bit of the encryption key.

6. b) Swap the left child and the right child of an interior node, if the corresponding encryption bit is 1.

7. A method of introducing randomness into the process of the arithmetic coding by shuffling the interval table with an encryption key. That is, a method of introducing randomness into the process of the arithmetic coding by changing the order of dividing an interval into smaller intervals with an encryption key.
